(19) United States
(12) Patent Application Publication
(10) Pub. No.: US 2026/0092842 A1
(43) Pub. Date: Apr. 2, 2026

(54) OPEN-ACCESS SYSTEMS FOR SAMPLE IDENTIFICATION

(71) Applicant: Manta Biosystems, Inc., Beverly, MA (US)

(72) Inventor: John Frederick Regan, South Hamilton, MA (US)

(21) Appl. No.: 19/340,504

(22) Filed: Sep. 25, 2025

Related U.S. Application Data
(63) Continuation-in-part of application No. 17/614,045.
(60) Provisional application No. 62/853,759, filed on May 29, 2019.

(51) Int. Cl. G01N 1/38

(52) U.S. Cl. CPC G01N 1/38

(57) ABSTRACT

Aspects herein relate to customizable open-access systems for sample identification. The systems are designed to use single-use and multi-use consumables, including, but not limited, to multi-use fluid containers containing large volumes of fluids. In some embodiments, the open-access systems extract and purify genetic material and identify nucleic acids in samples using polymerase chain reaction (PCR). In some embodiments, the fluid containers are a customizable liquid pack, where the multi-use consumables include connectors configured to permit the connection of at least one fluid container to an extension portion. Moreover, the system may permit various testing cycles, with different types of fluids, including, but not limited to, sample preparation buffers and reagents.

### CROSS-REFERENCE TO RELATED APPLICATIONS

This application is a continuation in part of U.S. application Ser. No. 17/614,045, which is a national stage entry of PCT/US2020/034179, filed on May 22, 2020, which claims the benefit under 35 U.S.C. § 119 (e) of U.S. provisional application No. 62/853,759, filed May 29, 2019, the contents of which are herein incorporated by reference in their entirety.

### FIELD

Aspects described herein generally relate to systems for sample identification. Aspects described herein more specifically relate to open-access systems for identifying nucleic acids in a sample.

### BACKGROUND

Systems can be used for sample identification, such as identifying nucleic acids in a sample.

### SUMMARY

Aspects described herein relate to an arrangement for open-access testing. A fluid container capable of open-access testing may be used in a plurality of testing applications. For example, the open-access testing capability may allow for newly designed ‘PCR’ tests to be incorporated quickly by the end user into a system that allows for fully-automated genetic testing. In some embodiments, this may include rapid custom testing for newly emerged pathogens that have the potential to cause harm (e.g., infect other people or become an epidemic or pandemic). Alternatively, or additionally, the open access testing capacity may be used in screening bio-reactors for a new microbial contaminant.

Moreover, in the biopharmaceutical industry, bioreactors need to be screened for microbes. Typically, microbes are divided into 4 main categories for biopharma purposes, namely: total bacteria, total fungi, mycoplasma, and common viruses. In some cases, the biopharmaceutical industry may be in a binary, yet quantitative, measurement where a sample is deemed positive or negative. For positive samples, it may be advantageous to report back a rough estimate of the amount of contaminating microbial genetic material. In some embodiments, the test may not only report when a sample is positive, which for example, may occur when the total bacteria test is positive; the test may further identify the type of contamination, for example identifying the specific type of bacteria with a “bad actor” test that may screen for a prescribed list of contaminants, which may be those that are commonly encountered. However, it should be appreciated that such tests may not always provide the identity of the microbe, as the contaminant may not be commonly encountered. As such, a second test for an atypical contaminant, which can screen for the new microbe in isolation, or during the same time as repeating the total bacteria test, may be incorporated into testing methodologies. The open-access feature enables flexibility in directing the fully automated and integrated PCR system by enabling an end user to select what to screen the samples against.

Unless otherwise defined, all terms used herein have the same meaning as commonly understood by one of ordinary skill in the art to which the invention pertains. All publications, patent applications, patents, and other references mentioned herein and/or listed in the Application Data Sheet are hereby incorporated by reference in their entirety. In case of conflict, the specification, including definitions, will control. When a range of values is provided, the range also includes the end values.

The materials, methods, components, features, embodiments, examples, and drawings disclosed herein are illustrative only and not intended to be limiting.

### DESCRIPTION OF DRAWINGS

The invention is best understood from the following detailed description when read in connection with the drawings disclosed herein, with like elements having the same reference numerals. When a plurality (two or more) of similar elements are present, a single reference numeral may be assigned to the plurality of similar elements with a small letter designation referring to specific elements. When referring to the elements collectively or to a non-specific one or more of the elements, the small letter designation may be dropped. The various features of the drawings may not be drawn to scale and may be arbitrarily expanded or reduced for clarity. Included in the drawings are the following figures:

FIG. 1 is a diagram depicting a system for loading at least one fluid;

FIG. 2 is a diagram depicting the system of FIG. 1 after a bay of the system is raised;

FIG. 3 is a diagram depicting a system for loading at least one fluid;

FIG. 4 is a diagram depicting the system of FIG. 3 after a manifold of the system is lowered;

FIG. 5A is a diagram depicting a fluid container;

FIG. 5B is a perspective view of the fluid container of FIG. 5A;

FIG. 6A is a diagram of a bay;

FIG. 6B is the bay of FIG. 6A with a fluid container loaded into the bay;

FIG. 7 is a schematic representing a system for sample identification;

FIG. 8 is a schematic representing a system for sample identification using PCR;

FIG. 9 is a perspective view of the of a customizable fluid container;

FIG. 10A depicts a top view of a customizable liquid pack according to one embodiment;

FIG. 10B depicts a top view of a customizable liquid pack according to a second embodiment;

FIG. 10C depicts a customizable liquid pack according to a third embodiment, where an auxiliary hub is disconnected from the customizable liquid pack;

FIG. 10D depicts the customizable liquid pack of FIG. 10C, where the auxiliary hub is attached to the customizable liquid pack;

FIG. 11 depicts loading a customizable liquid pack into a bay of a sample processing device;

FIG. 12A depicts a bay of sample processing device with a customizable liquid pack loaded therewithin and in a fluidly disconnected configuration;

FIG. 12B depicts the bay of FIG. 12A where the sample processing device is fluidly coupled to the preselected receptacle;

FIG. 12C depicts the bay of FIG. 12A where the sample processing device is fluidly coupled to the preselected receptacle and the insertable receptacle;

FIG. 13A depicts a bay of the sample processing device with a customizable liquid pack loaded therewithin and in a fluidly disconnected configuration;

FIG. 13B depicts the bay of FIG. 13A with a first preselected elevator raised;

FIG. 13C depicts the bay of FIG. 13A where the sample processing device is fluidly coupled to the customizable liquid pack;

FIG. 14A depicts fluid inlets of a sample processing instrument engaging with a liquid pack according to one embodiment;

FIG. 14B depicts fluid inlets of a sample processing instrument and associated customizable liquid pack according to a second embodiment;

FIG. 15 is a method of processing a sample with a customizable liquid pack; and

FIG. 16 is a flow chart depicting operating a sample processing device with a customized cartridge.

### DEFINITIONS

To facilitate understanding of the invention, a number of terms are defined in alphabetical order herein.

“Fluid container” means a container containing at least one fluid in at least one fluid reservoir. A fluid container includes but is not limited to a vessel, rack, frame, and plate.

“Fluid reservoir” means a defined area of the fluid container that can hold at least one fluid. A fluid reservoir includes but is not limited to a well, tube, tubing, channel, and compartment.

“PCR master mix” means a solution of reagents for a polymerase chain reaction (PCR) reaction. A PCR master mix typically includes polymerase and deoxynucleotides (dNTPs) (and/or similar nucleotides) and typically does not include probes or primers. In the context of this technology, isothermal amplification is included under the PCR umbrella, although one works by thermal cycling, whereas the other works at a single temperature.

“Reagent pack”, “liquid pack” and/or “fluid pack” means a fluid container containing at least one reagent in at least one fluid reservoir. An example of a reagent pack includes but is not limited to a rack with at least one tube wherein the at least one tube contains at least one reagent, a frame with at least one tube wherein the at least one tube contains at least one reagent, a plate with a least one well wherein the at least one well contains at least one reagent, a plate with at least one channel wherein the at least one channel contains at least one reagent, and a vessel with at least one compartment wherein the at least one compartment contains at least one reagent.

“Fluid” means any type of gas and/or liquid. In some embodiments, a fluid refers to solely a liquid element of a device. In some embodiments, the fluid is a “working liquid”, which may be a liquid and may include reagents, buffers, solutes and any fluid that is used in processing and/or assaying cells. However, this should not be construed as limiting, as any fluid used to process and assay a sample may be used.

### DETAILED DESCRIPTION

According to some aspects described herein, a system may include a mechanism by which working liquids, which may include liquid buffers and/or reagents, are provided to a microfluidic device in bulk multi-use reservoirs. This methodology may simplify the manufacturing process, which may lower the cost per test. Moreover, in some embodiments, it may be beneficial for the fluid containers to be shipped to an instrument operator prior to being filled with a processing solution, and the container may be configured to permit the operator to fill the receptacles with their own working liquids. Alternatively, the fluid container may be shipped with at least some of, or all, the receptacles filled with working liquid. Accordingly, preparation of the sample during sample processing and analysis of the sample during sample testing/assaying with the sample processing instrument may be conducted in an automated fashion, for example with a robotic well plate mover, which may further decrease operational costs associated with sample identification. To further drive efficiency, working liquids including liquid buffers and reagents may be stored in said reservoirs within the sample processing instrument in a sufficient quantity to be used with multiple single-use sample cartridges.

The identification system can be the same as or similar to the system disclosed in U.S. Pat. No. 8,298,763 and hereby incorporated by reference in its entirety. The identification system can be used to detect and identify molecular targets (e.g., microbes, cancer markers, etc.) in a variety of samples for a variety of purposes. For a first example, the identification system can be used to identify samples from animals for veterinarian purposes. For a second example, the identification system can be used to identify samples from fruits and vegetables for food-safety purposes. For a third example, the identification system can be used to identify samples from water for water quality monitoring purposes. For a fourth example, the identification system can be used to identify samples from humans for biosafety purposes. For a fifth example, the identification system can be used to identify samples from humans and/or animals for genetic screening and/or pathogen testing purposes. For a sixth example, the identification system can be used to screen for microbes inside bioreactors or inside cell and gene therapies used in personalized medicine.

In some embodiments, the system permits ‘open-access’ testing at the point of need. Typically, diagnostic devices are ‘closed-access’, meaning that the end-user has no ability to add reagents to a system that allow for customized testing. Closed-access diagnostic systems may only be manufactured in one or at most very few manufacturing sites. In some instances, closed-access systems have all the ‘PCR’ reagents embedded within the single-use consumables. The manufacturing of such consumables is typically complicated, as it may require specialized equipment. If there is a need for a surge in manufacturing capability due to an unanticipated demand for a particular test, which might occur when a novel pathogen emerges that presents a risk for increased morbidity and mortality, then the limited manufacturing plants and complexity of manufacturing may result in a bottleneck that can delay the time it takes to get a new test into the ‘field’ for rapid testing in the locations where it is needed. This location may be in a medical clinic, veterinary clinic, biomanufacturing plant, etc. Decreasing this time delay in getting tests to point-of-need testing locations may be highly desirable.

The inventor(s) have appreciated that one way to overcome such an obstacle is to promote the use of ‘open-access’ technologies at the point-of-need. Open-access technologies can accept reagents in bulk reagent reservoir format that enable open-access technologies to have expanded custom testing capabilities. Such reagents, such as primers and probes, may be manufactured by numerous manufacturers, and these can be delivered directly to fully automated open-access systems in days (rather than going through the manufacturer of said system for these reagents). Accordingly, open-access technologies may enable customized (user-directed) testing at the point of need in days rather than months. This may mean the difference between successful containment of a novel pathogen capable of causing a pandemic and failed containment because in-field testing could not be realized soon enough, which may result in sufficient time for a deadly pathogen to spread and have enough hosts where containment becomes challenging if not impossible or nearly impossible.

Another example aside from rapid detection of a newly emergent pathogen of either humans or animals is the desire to rapidly identify a microbe in a biomanufacturing plant. The faster this can be done, the less opportunity/time the microbe has to spread to other parts of the plant, and therefore the faster the plant can resume manufacturing ‘clean’ product. Such improvements in speed at getting custom testing technologies operational at the point of need can translate into significant time and resource savings for each microbial contamination incident inside a manufacturing plant.

Importantly, the open-access system may allow for the system to either add a new test to a standard single or multiplex test that is run-thereby expanding the plex of the test, or simply swap out one test for a new test. Flexible open-access systems allow for such custom testing where newly added tests work by addition or substitution (even though the test substituted out may not necessarily be physically removed from the system).

In some embodiments, more specific fluid reagents may be required to adequately test for less routine sample identification. As such, the liquid pack may contain one or more couplings or other arrangements that permits a user to modify the liquid pack, e.g. by adding or removing additional selectable receptacles. These additional receptacle(s) may not be essential for a general test and/or may only be used in select circumstances. For example, a selectable receptacle may be used once a particular class or genus of pathogen is detected (e.g. as a non-limiting example, if the sample is identified as the general genus of Streptococcus, then the specific strain such as Streptococcus equi may be targeted with the selectable receptacle). Such use may be applicable when certain targets are atypical and/or not routinely required, such as in cases where there are small patient demographics, the pathogen is not routinely uncovered in a sample population, and/or a new pathogen has emerged.

As will be appreciated, the customizable liquid pack may enable rapid incorporation of reagents (including primers and/or probes) and other types of working liquids that permit the detection of newly identified targets within automated systems, as the system is configured to incorporate new testing solutions such as reagents, into prefabricated and loaded cartridges. As such, identification of samples containing new pathogens, biomarkers, and/or other testing targets may be achieved.

A working liquid may include any liquid that may be used in sample preparation, any suitable reaction, and/or any testing/assay process. In some embodiments, a working liquid includes a reagent used in a sample assay. For example, the working liquid may comprise primers, nucleic acids, a DNA polymerase and other reagents known for the PCR process and that may be specific for the type of PCR, for example reverse transcriptase for RT-PCR, and or other assays used to qualify or quantify the presence of the expanded DNA/RNA sequences, for example fluorescent probes and dyes. More specifically, working liquids may include enzymes used to assist in the lysis of cells such as lysozyme, protease K, lysostaphin, mutanolysin, endolysin, achromopeptidase, zymolyase, lyticase, chitinase, glucanase, cellulase, pectinase, hemicellulase, driselase, macerozyme, trypsin, collagenase, dispase, and DNase/RNas. This may include an amplification reagent, that is capable of forming an amplification byproduct, such as an amplicon. In some embodiments, the working liquid may include a saline solution and/or other aqueous solutions; an alcohol; an oil; chaotropic salts-based lysis buffers, wash buffers, and viability dyes such as PMAxx and/or PMA.

In the loading system, at least one needle or other fluid inlet (that is used to interface with the at least one fluid in the fluid container) is directly attached to or in close proximity to a manifold, thereby eliminating or reducing the tubing and/or microfluidic channels between the at least one needle and the manifold. In addition, a valve is directly attached to or in close proximity to the manifold, thereby eliminating or reducing the tubing and/or microfluidic channels between the valve and the manifold. In some embodiments, the bay (that receives the fluid container) is raised to establish fluidic connectivity between the at least one needle and at least one fluid in a fluid container. In other embodiments, the manifold is lowered to a fluid container to establish fluidic connectivity between the at least one needle and at least one fluid in a fluid container. In other embodiments, the bay is raised and the manifold is lowered to establish fluidic connectivity between the at least one needle and at least one fluid in a fluid container.

In some embodiments, the system may include the use of fluid containers with large volumes of at least one fluid. The large volumes of the at least one fluid in combination with the minimized volumes of the fluidics in the identification system allows the at least one fluid to be used multiple times, meaning the at least one fluid is pumped to the reaction site multiple times. The number of times that the at least one fluid can be pumped to the reaction site includes but not limited to 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, 300, 400, 500, or more times. In some embodiments, the fluid container is a reagent pack containing at least one fluid reservoir containing a PCR master mix and at least one fluid reservoir containing at least one probe and at least one set of primers, and the reagent pack is used at least 10 times, meaning that the reagents are pumped from the reagent pack to the reaction site at least 10 times.

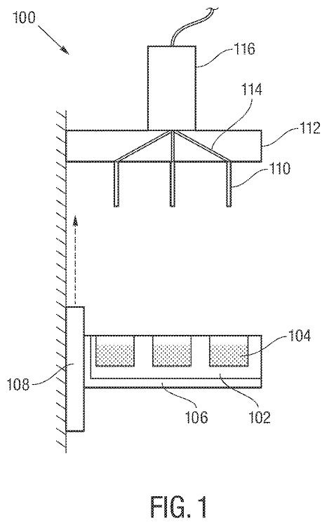

FIG. 1 is a diagram depicting one illustrative embodiment of a system for loading at least one fluid. In this diagram, the loading system 100 includes a fluid container 102, three fluids 104 (in three fluid reservoirs), a bay 106, an elevator 108, three needles 110, a manifold 112, three microfluidic channels 114, and a valve 116. The three fluids 104 are in the fluid container 102. Three fluids were chosen in this diagram for illustrative purposes only and any amount of fluids could be in the fluid container including but not limited to 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, or more fluids. Each fluid can be in any type of fluid reservoir. The fluid reservoir can be a permanent part of a fluid container and therefore not removable from the fluid container. For example, a non-removable fluid reservoir can be a well or a permanently attached tube in a fluid container. Alternatively, a fluid reservoir can be a non-permanent part of a fluid container and therefore removable from the fluid container. For example, a removable fluid reservoir can be a tube that is removably attached to the fluid container by, for example, snapping (inserting) the tube into a hole in the fluid container. An example of a suitable tube includes but is not limited to the Micrewtube® graduated tube (Simport Scientific, Beloeil, Quebec, Canada).

In FIG. 1, the fluid container 102 is loaded into or onto the bay 106, which is configured to receive the fluid container, and the bay is connected to the elevator 108. A fluid container can be loaded into or on a bay in a number of methods including but not limited to top-loaded, front-loaded, back-loaded, side-loaded, bottom-loaded, and a combination thereof. Examples of loading methods include but are not limited to placing (moving substantially vertically) a fluid container into or onto a bay, sliding (moving substantially horizontally) a fluid container into or onto a bay, and a combination thereof. A fluid container can also be loaded in a two-step process such as first placing a fluid container into or onto a bay and then sliding the fluid container and bay into or onto a loading system so that the fluid container and bay engage with an elevator. In this diagram, the elevator 108 is attached to the bay 106 so that the elevator can raise the bay. An elevator and a bay can be permanently or removably attached. For example, an elevator can be welded (permanently attached) to a bay or magnetically connected to a bay (removably attached). In other embodiments, a bay and an elevator are the same unit. A bay can be raised by a number of methods including but not limited to a piston to push the bay, an electric motor that raises the bay (in some embodiments, an elevator connected to the bay) along a rod, chain, track, and/or cable, and the manual or automated insertion of a wedge under the bay to push the bay. The dashed arrow represents the raising of the bay. In this diagram, the elevator 108 raises the bay to the three needles 110, which are in fluidic connectivity with the manifold 112, so that the three needles 110 interface with the three fluids 104 to establish fluidic connectivity between the three needles 110 and the three fluids 104. Fluidic connectivity can be established by the three needles 110 fully or partially entering the three fluids 104. Three needles were chosen in this diagram for illustrative purposes only but any amount of needles could be in fluidic connectivity with a manifold including but not limited to 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, or more needles. The manifold 112 can be made of any rigid material including but not limited to metal or plastic. In a preferred embodiment, the manifold is made of a thermoplastic.

In FIG. 1, the number of needles and fluids are the same (three) for illustration purposes only, and the number of needles and fluids can be different. For example, a loading system can have a manifold in fluidic connectivity with four needles and a fluid container with 16 fluids. In addition, in some embodiments the needles and/or the fluids are independently moveable. In this diagram, the three needles 110 are attached directly to the manifold 112, however, one or more needles can be in fluidic connectivity with a manifold by tubing and/or additional microfluidic channels. The manifold 112 contains three microfluidic channels 114 with each microfluidic channel having an inlet connected to a needle 110 and an outlet in fluidic connectivity with the valve 116. In preferred embodiments, the loading system contains the same number of needles as there are fluids in the fluid container.

In FIG. 1, the valve 116 is attached directly to (mounted on) the manifold 112 however, a valve can be in fluidic connectivity with a manifold by tubing and/or additional microfluidic channels. Each microfluidic channel can have any shape and dimension but, in preferred embodiments, each microfluidic channel has a volume between 5 μL and 25 μL, preferably a volume of no more than 20 μL. The valve 116 can be any type of microfluidic valve and in preferred embodiments is attached directly to (mounted on) the manifold 112. In this diagram, the three fluids 104 in the fluid container 102 are pumped through the three needles 110 through the three microfluidic channels 114 and into the valve 116. The valve 116 selectively allows at least one fluid at a time to travel out of the valve 116 and towards a reaction site (not depicted).

A loading system is typically part of an identification system (other components of identification system not depicted). The loading system is designed to minimize the volume of the fluidics, along with the other components of the identification system, to allow for reusable consumables such as fluid containers (including reagent packs), and sample preparation cartridges. In FIG. 1, the three needles 110, the manifold 112, and the valve 116 are all directly attached to (mounted on) one another to minimize the volume of the fluidics of the loading system. A person skilled in the art will understand that tubing and/or additional microfluidic channels can be used anywhere in the loading system, but it will add to the volumes of the loading system and thereby reduce the value of the loading system as part of an identification system.

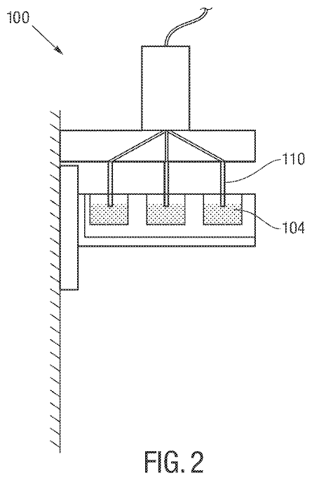

FIG. 2 depicts the loading system 100 after the bay is raised and the three needles 110 are in fluidic connectivity with the three fluids 104.

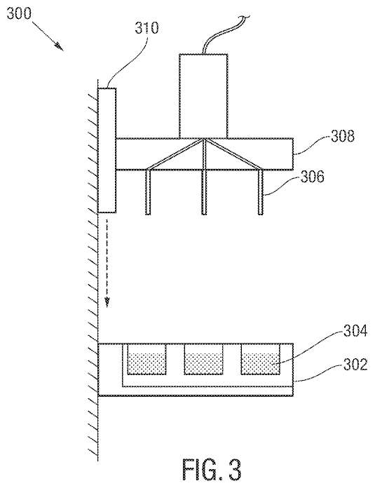

FIG. 3 is a diagram depicting an embodiment of a system for loading at least one fluid. A loading system 300 in FIG. 3 is similar to the loading system 100 in FIG. 1. However, unlike the loading system 100, a manifold 308 of the loading system 300 is lowered to the fluid container 302 to establish fluidic connectivity between three needles 306 and three fluids 304 (in three fluid reservoirs). The manifold 308 is attached to an elevator 310 so the elevator 310 can lower the manifold. An elevator and a manifold can be permanently or removably attached. For example, an elevator can be welded (permanently attached) to a manifold or magnetically connected to a manifold (removably attached). In other embodiments, a manifold and an elevator are the same unit. A manifold can be lowered by a number of methods including but not limited to a piston to push the manifold, an electric motor that lowers the manifold (in some embodiments, an elevator connected to the manifold) along a rod, chain, track, and/or cable, and the manual or automated insertion of a wedge above the manifold to push the manifold.

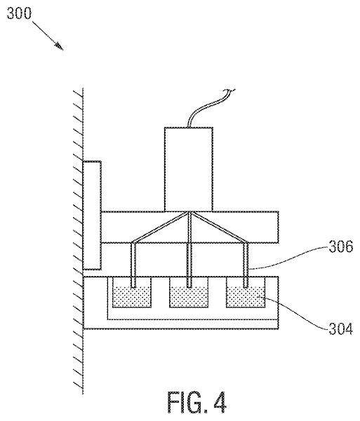

FIG. 4 depicts the loading system 300 after the manifold is lowered and the three needles 306 are in fluidic connectivity with the three fluids 304.

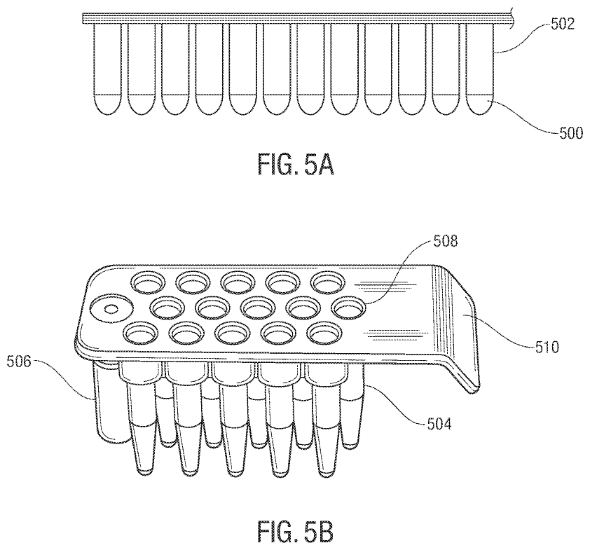

FIGS. 5A and 5B are diagrams depicting two fluid containers. FIG. 5A is a diagram depicting a fluid container containing fluids 500 in fluid reservoirs 502. The fluid reservoirs 502 are arranged in a single row. Each fluid 500 can be any fluid including but not limited to reagents. In this diagram, the fluid reservoirs 502 are tubes and the tubes can be either fixed or removable. In some embodiments, a fluid container and fluid reservoirs are the same unit. A fluid container can be made of any rigid material including but not limited to metal and plastic and can be created by a variety of methods including molding, extrusion, and additive manufacturing (3D printing). 3D printing a fluid container with holes and then inserting standard size (off-the-shelf) tubes into the holes (to create a finished fluid container) reduces the cost of manufacturing and therefore reduces the cost to the purchaser/user. Each fluid in a fluid container can have any volume that can be contained in a given fluid reservoir of the fluid container including but not limited to 10 microliters (μL), 20 μL, 30 μL, 40 μL, 50 μL, 60 μL, 70 μL, 80 μL, 90 μL, 100 μL, 150 μL, 200 μL, 250 μL, 300 μL, 350 μL, 400 μL, 450 μL, 500 μL, 600 μL, 700 μL, 800 μL, 900 μL, 1000 μL, 1500 μL, 2000 μL, 2500 μL, 3000 μL, 3500 μL, 4000 μL, 4500 μL, 5000 μL, 6000 μL, 7000 μL, 8000 μL, 9000 μL, 10000 μL, or more μL. In preferred embodiments, each fluid has a volume between 200 μL and 1000 μL.

FIG. 5B is a diagram depicting a fluid container containing 16 fluid reservoirs in the form of two types of tubes (in multiple rows), which are 15 smaller-volume tubes 504 and a larger-volume tube 506. In some embodiments, the larger-volume tube 506 contains a PCR master mix and the 15 smaller-volume tubes 504 contain other PCR reagents such as aqueous PCR assays. Each of the 15 smaller-volume tubes can contain the same or different aqueous PCR assays. In other embodiments, the larger-volume tube 506 contains a PCR master mix and the 15 smaller-volume tubes 504 contain a combination of PCR reagents such as aqueous PCR assays and cleaning fluids used to periodically clean and/or sterilize the identification system. In these embodiments, the PCR reagents and the cleaning fluids are in different tubes.

Each tube (also referred to as a “receptacle”) contains an opening that permits a sample processing instrument to access at least one working liquid within the tube. These openings may be aligned on the top end of the fluid container and oriented towards a single direction, which may be upward. This top end may be a portion of the fluid container that opposes a bottom end of the device, where the bottom end retains the working liquid. The top portion of the fluid container may orient the openings to be in a position so that when the device is positioned or otherwise loaded into the sample processing instrument, the openings are in a position where they can interface with the inlet (e.g., needles) of the sample processing instrument.

Each tube contains a membrane covering its opening, which is punctured by a needle when the fluid container (loaded in a bay) is raised to the needle (which is in fluidic connectivity with a manifold). The membrane can be made of rubber, silicone, or a similar elastomer and can be pre-slit to facilitate puncturing and also resealing when a needle is removed. The membrane helps to prevent the evaporation of the fluid in the tube and also helps to prevent contamination. A fluid container can also include at least one additional layer of material on top of some or all of the fluid reservoirs. The at least one additional layer includes but is not limited to at least one additional membrane, a metal film (such as an aluminum or aluminum mylar film), and a printed label that covers all or part of the top of the fluid container and identifies the fluid(s) in the fluid reservoir(s). The fluid container depicted in FIG. 5B includes a handle 510 to facilitate the loading and unloading of the fluid container. A fluid container can have any shape, such as square or circular, and fluid reservoirs can be in a regular pattern, such as rows and/or circles, or in an irregular pattern.

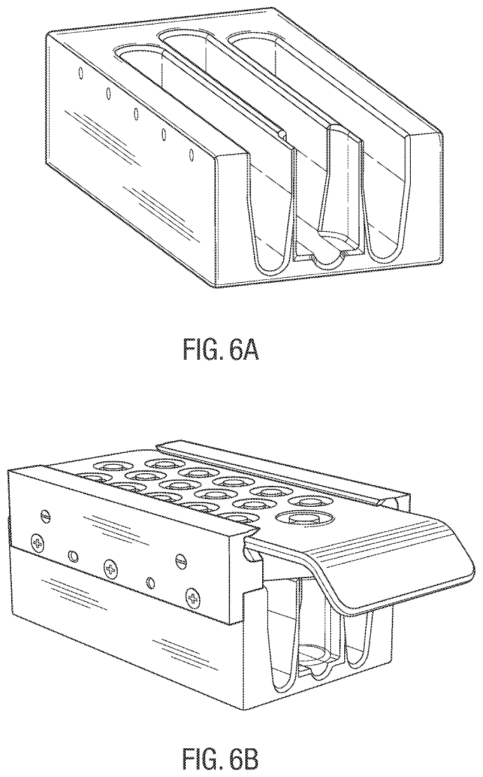

FIG. 6A is a diagram depicting a bay configured to receive a fluid container. A bay can be designed to cool part or all of a fluid container by passive and/or active cooling and can be made of any rigid material, preferably a metal or metal alloy. Cooling can be by any method including but not limited to convection, conduction, and radiation. In preferred embodiments, the fluid container is cooled by a Peltier cooling device to a temperature between 4 degrees Celsius (° C.) and 8° C. Cooling all or part of a fluid container helps to extend the life of the fluid(s) in a fluid container and prevent evaporation. In this embodiment, the bay receives the fluid container by sliding to front-load the fluid container. FIG. 6B is a diagram depicting the bay of FIG. 6A loaded with a fluid container. A bay and a fluid container can be designed to reversibly lock together.

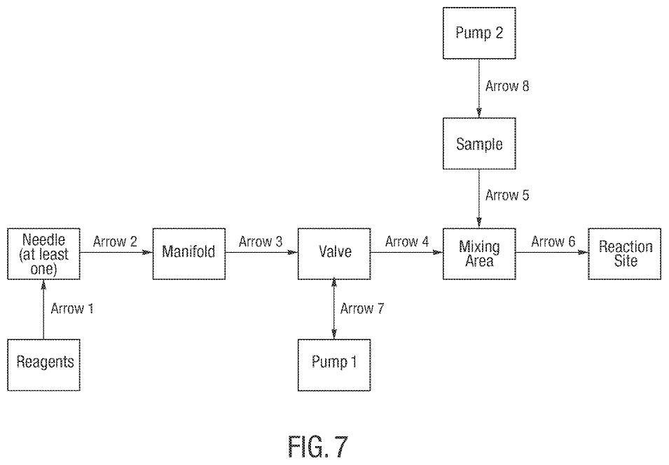

FIG. 7 is a schematic representing one embodiment of a system for sample identification in. In this schematic, the boxes represent components of the system and the arrows represent fluidic connectivity between components and the direction of fluid flow. For example, arrow 4 between the valve and the mixing area represents that the valve and mixing area are in fluidic connectivity and that fluid flows from the valve to the mixing area. The arrows can also represent a means of fluidic connectivity between components including but not limited to tubing and microfluidic channels. For example, arrow 4 between the valve and the mixing area can also represent at least one tubing and/or microfluidic channel between the valve and the mixing area. All of the components of FIG. 7 are in fluidic connectivity with one another. The reagents, which are in a fluid container, flow to the at least one needle, then to the manifold, then to the valve, then to the mixing area (where the reagents are mixed with sample) and then to the reaction site. In this schematic, pump 1, which is in bidirectional fluidic connectivity with the valve, and pump 2, which is in unidirectional fluidic connectivity with the sample, cause fluid flow. In a preferred embodiment, arrow 1 represents fluidic connectivity only and is not a means of connectivity (for example, is not at least one tubing and/or microfluidic channel) because the at least one needle is fully or partially in the reagents (directly connected to the reagents) and therefore is the means of fluidic connectivity between the reagents and the manifold, arrow 2 and arrow 3 each represent fluidic connectivity only and are not a means of connectivity because the at least one needle and valve are both attached directly to (mounted on) the manifold (and the at least one microfluidic channel in the manifold is the means of fluidic connectivity between the at least one needle and the valve), arrow 4 is at least one tubing, arrow 5 is at least one tubing, arrow 6 is at least one tubing, arrow 7 is at least one tubing, and arrow 8 is at least one tubing. In some embodiments, to minimize the volume of the fluidics in the schematic, the volume for each of the means of connectivity (arrows) can be minimized. In preferred embodiments, the volume of arrow 1 is 0 μL (because the at least one needle is fully or partially in the reagents and is the means of fluidic connectivity between the reagents and the manifold), the volume of each needle is between 0.1 μL and 1 μL, the volume of arrow 2 is 0 μL, the volume of each microfluidic channel in the manifold is between 1 μL and 20 μL, the volume of arrow 3 is 0 μL, the volume of each tubing of arrow 4 is between 2 μL and 100 μL, the volume of each tubing of arrow 5 is between 5 μL and 300 μL, the volume of each tubing of arrow 6 is between 2 μL and 25 μL, the volume of each tubing of arrow 7 is between 5 μL and 100 μL, and the volume of each tubing of arrow 8 is between 5 μL and 100 μL. In preferred embodiments, the volume of the fluidics of the entire system for sample identification (including components and the fluidic connectivity between the components) is not greater than 375 μL.

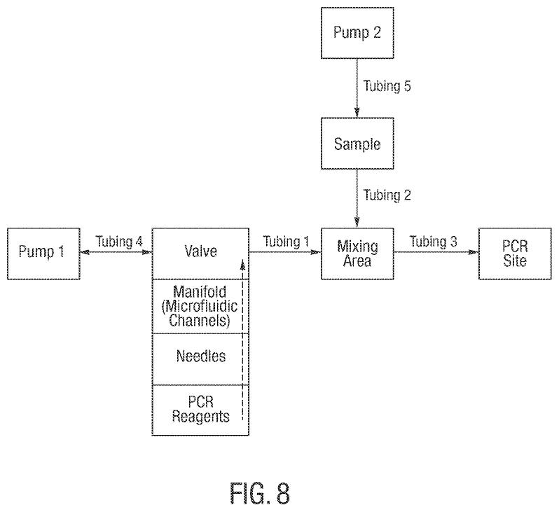

In FIG. 7, pump 1 and pump 2 can each be any microfluidic pump including but not limited to a peristaltic pump, syringe pump, pressure pump, and positive displacement pump. An example of a microfluidic pump is a PSD/4 Precision Syringe Drive (Hamilton Company, Reno, Nevada, USA). The valve can be any microfluidic valve, for example the TitanHT™ rotary shear valve (IDEX Corporation, Lake Forest, Illinois, USA). The mixing area can be any microfluidic mixing area and can use passive and/or active mixing. For example, the mixing area can be a serpentine shaped microfluidic channel (passive mixing) or a magnetic micro-stirrer (active mixing). The sample may contain at least one nucleic acid of interest (also referred to as a “target nucleic acid”), and, in some embodiments, the at least one nucleic acid of interest is identified by fluorescence-based PCR. The reaction site is where the reaction occurs. Types of reaction sites include but are not limited to defined flow paths, including but not limited to tubing and microfluidic channels, and flow cells. Defined flow paths are disclosed in U.S. Provisional Patent Application No. 62/839,845, which is hereby incorporated by reference in its entirety. FIG. 8 is a schematic representing one embodiment of a system for sample identification using PCR. In this schematic, the reagents are PCR reagents and are in tubes. At least one tube is a PCR master mix and at least one tube is an aqueous PCR assay including but not limited to at least one probe and at least one set of primers. The probe is a fluorescent probe such as a TaqMan® probe (Thermo Fisher Scientific, Waltham, Massachusetts, USA), which is a probe linked to a fluorophore and a quencher. The PCR reagents are pumped to the mixing area via the needles, the microfluidic channels in the manifold, the valve, and tubing 1 where they are mixed with the sample, which may contain at least one target nucleic acid, to create reaction mixtures. The sample is pumped to the mixing area via tubing 2. The reaction mixtures are then pumped to the PCR reaction site via tubing 3 where fluorescence-based PCR occurs. In fluorescence-based PCR, at least one fluorescent probe fluoresces under certain conditions, and the fluorescence is captured (imaged) and used to determine if the at least one target nucleic acid was present in the sample. If the at least one target nucleic acid was present in the sample, then it may be possible to identify the sample. Pump 1 is in bidirectional fluidic connectivity with the system for sample identification via tubing 4, and pump 2 is in unidirectional fluidic connectivity with the system for sample identification via tubing 5.

In FIG. 8, the needles are mounted on a side of the manifold and the valve is mounted on the same or another side of the manifold. Each needle is connected to the valve via a microfluidic channel in the manifold. The dashed arrow represents the flow of PCR reagents to the valve. In a preferred embodiment, the PCR reagents are in a reagent pack comprising 16 fluid reservoirs in the form of 16 tubes. Sixteen needles are mounted on a side of the manifold and the needles are in fluidic communication with the PCR reagents in the 16 tubes.

While two pumps are shown in FIGS. 7 and 8, it should be appreciated that in other embodiments, a system for sample identification may have only a single pump.

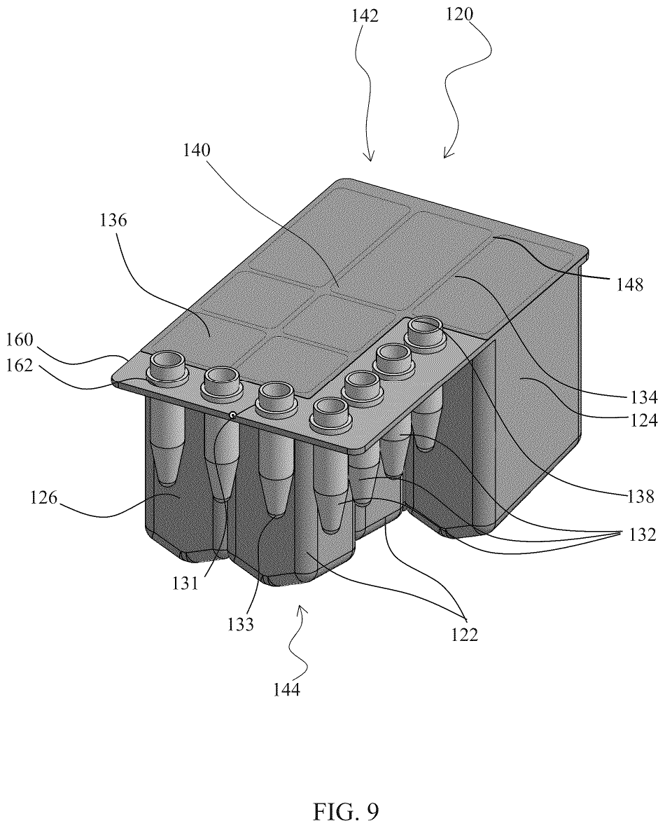

It should be appreciated that the components described above and/or otherwise associated with the embodiments detailed FIGS. 1-8, that are not inconsistent with the embodiments below, may be applied to the disclosure below and/or the embodiments detailed in FIGS. 9-16.

FIG. 9 depicts a customizable liquid pack 120 with a plurality of receptacles.

Some of the receptacles may be fixed receptacles, such as receptacles 122, 124, and 126, which are integrally formed with, or otherwise not configured to be removed from, the customizable liquid pack 120. The customizable liquid pack 120 may also receive one or more insertable receptacles 132

The first fixed receptacle 124 may have a first opening 134, the second receptacle 126 may have a second opening 136, and the third insertable receptacle 132 may have a third opening 138. These openings may be positioned along a top end 142 of the customizable liquid pack 120. For example, the first opening 134 of the first receptacle 124, and the second opening 136 of the second receptacle 126 may be positioned along a top horizontal plane of the customizable liquid pack 120. This top end 142 may include a frame 148 that connects the openings 134, 136 of the first receptacle 124 and second receptacle 126. This top end 142 may be configured to be oriented towards a sample processing instrument, or more specifically, towards one or more fluid inlets of a sample processing instrument.

Each of these openings may be sealed in a closed configuration so that a working liquid within the receptacles cannot be accessed and/or contaminated. However, once the opening is unsealed/opened, then the working liquid may be accessed by a sample processing instrument. In some embodiments, such as those illustrated in FIG. 9, a single seal 140 covers all the fixed receptacles 122, 124, 126. However, in some embodiments, each of the fixed receptacles 122, 124, 126 may be independently sealed with individual seals.

As noted above, the seal(s) covering the receptacle openings may be formed by various structures and may be configured to be permanently unsealed or they may be resealable. For example, the seal may be a puncturable foil that is configured to be broken by an inlet of the sample processing instrument. The seal may also be a valve, such as a septum valve, that is pierced by a needle or other inlet of the sample processing instrument and reseals once fluid connectivity between the sample processing instrument and the customizable liquid pack 120 is unestablished (e.g. the needle/inlet of a sample processing instrument is removed from the fluid receptacle). However, a person of skill could recognize that any type of seal may be implemented and the above is not intended to be limiting. Moreover, each receptacle of the customizable liquid pack may contain more than one seal. For example, a receptacle may have both an inner resealable seal and an outer one-time use seal. The resealable seal may be positioned between the one-time use seal and the working liquid within the receptacle. In some embodiments, the resealable seal may permit removal of the customizable liquid pack 120 from the sample processing instrument and/or otherwise prevent contamination of the fluids within the receptacles. However, other means of reducing contamination may be achieved without the need for resealable seals.

In some embodiments, a low-density oil, such as mineral oil, may be added to at least one of the receptacles. This low density oil may reduce evaporation from the receptacle once the receptacle is loaded into the sample processing instrument, which may be beneficial because the receptacles may be designed to hold sufficient fluids to allow for numerous tests, for example 100 tests. Such evaporation may change the concentration of the reagents, which may impact sample identification. Moreover, such a fluid barrier may also reduce the chances of a contamination being introduced into a sample cartridge/sample processing instrument.

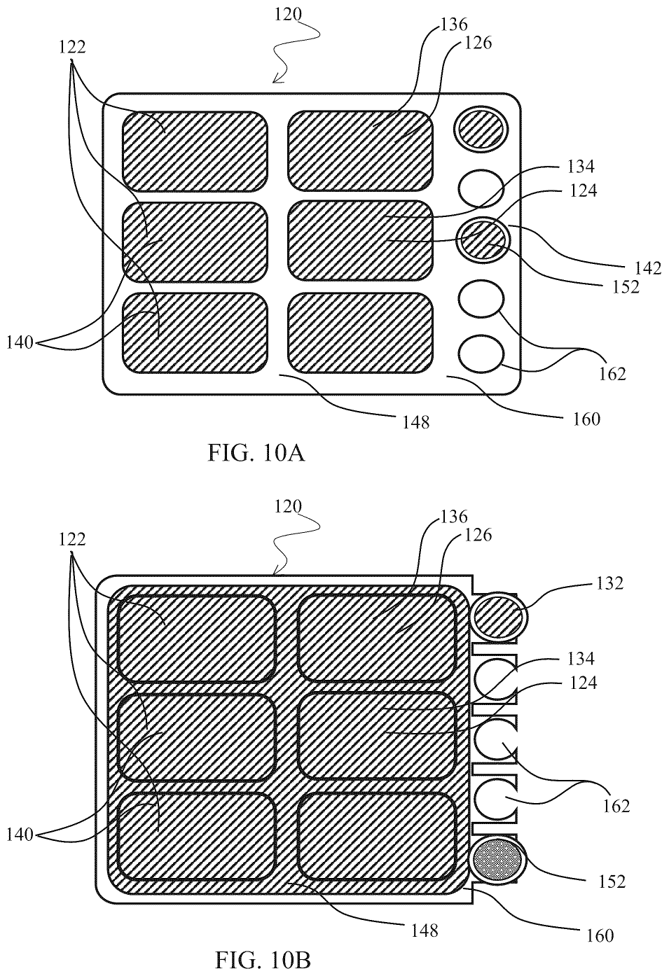

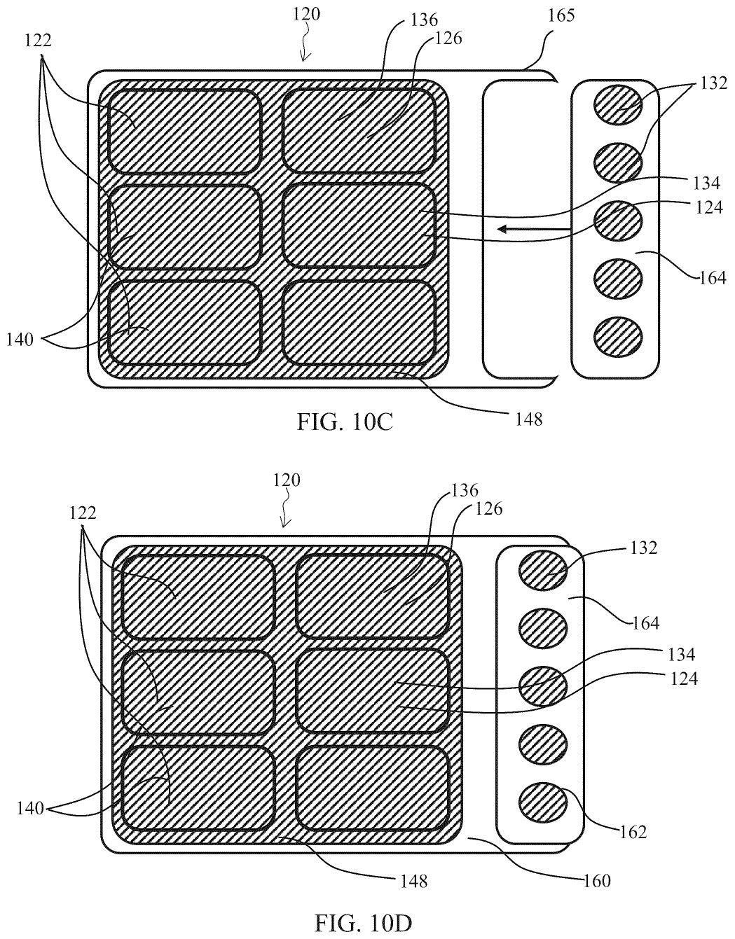

The seals 140 of the first, second, and third receptacles may be positioned along a top end 142 of the customizable liquid pack 120. The seals 140 may be connected to the top end 142 of the customizable liquid pack 120 or they may be positioned above or below this plane. For example, when a seal is disposed within the opening of a receptacle that is above the top end 142, like the insertable receptacle 132 in the embodiment detailed in FIG. 9, or when a seal is disposed within a fluid receptacle (and therefore below the top end 142). In some embodiments, seals align with, or are otherwise along a plane that is parallel to the top end 142, so that at least a first seal of the first receptacle 124, a second seal of the second receptacle 126 and a third seal (152 of FIG. 10A) of the third receptacle 132 are oriented towards (e.g. along a plane that is perpendicular to) the fluid inlets of at least one sample processing instrument.

Opposite to the top end 142 is the bottom end 144 of the customizable liquid pack 120. The bottom end 144 of the customizable liquid pack may be associated with the bottom of each of, some of, or at least one of the fluid receptacles. In FIG. 9, the bottom end 144 is associated with the fixed receptacles 122. However, in some embodiments, the bottom of customizable liquid pack 120 may not be the bottom of any of the fluid receptacles. For example, if there was a false bottom or another structure configured to space the bottom of the receptacle from the bottom (or the lowest point) of the customizable liquid pack 120. However, in some embodiments, the bottom of the customizable liquid pack 120 may not be the true bottom of the device, as instead it may be the bottom, or otherwise the lowest point of at least one of the fluid receptacles.

FIG. 9 depicts an example of a customizable liquid pack 120 with the insertable receptacles 132 loaded into the pack. The insertable receptacles 132 may be secured to an extension portion 160 of the customizable liquid pack 120. As will be detailed below, at least one coupling 162 may secure the insertable receptacle 132 to the extension portion 160.

In some embodiments, the customizable liquid pack may include an extension portion 160 configured to support the insertable receptacles.

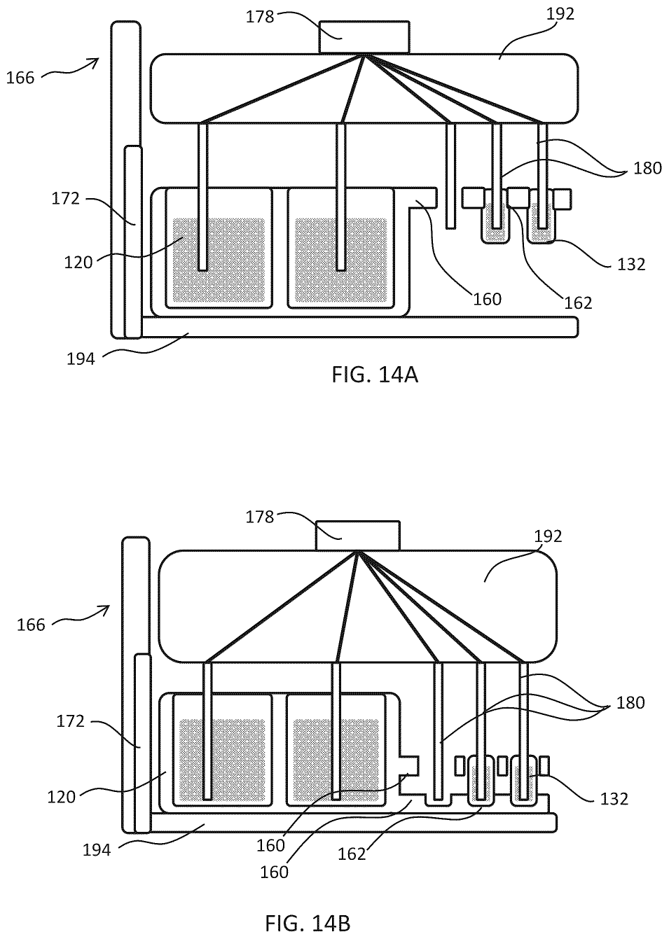

The extension portion 160 may be attached, either directly or indirectly to other fixed receptacles. For example, the extension portion may be coupled to a first receptacle 124 with a first fluid and a second receptacle 126 with a second working liquid. In some embodiments, the extension portion 160 may be integrally formed with the fixed receptacles or otherwise formed as a continuous structure. As noted above, the fixed receptacles may each contain an opening on the top end 142 of the customizable liquid pack 120. In some embodiments, the extension portion 160 may be aligned with (or otherwise flushed with) the openings of the fixed receptacles. In such embodiments, the extension portion 160 may be configured to position an opening of the insertable receptacles 132 slightly above the openings of the fixed receptacles 122. However, in other embodiments, the extension portion 160 and/or at least one coupling 162 may be configured to position the insertable receptacle 132 at a position that is in-line with or below (see FIGS. 14A-14B below) the fixed receptacles 122. For example, the extension portion 160 may be attached to a point on the first receptacle 124 and second receptacle 126 that is below at least one of their openings 134, 136, or the extension portion 160 may extend downwardly.

The extension portion 160 may be configured to support the insertable receptacles 132 in a position during operation of the sample processing instrument. As such, in some embodiments, the extension portion 160 may be fabricated from a rigid material to decrease deformation of the extension portion 160 and/or maintain the relative position of the insertable receptacle 132 during operation of the sample processing device. Alternatively, or additionally, the extension portion 160 may contain additional structural support elements that provide additional robustness to the structure. For example, the extension portion may be a cantilevered support and/or contain a cantilever support brace. However, other support structures may be implemented, and the above disclosure is not intended to be limiting. Moreover, in some embodiments, the extension portion 160 may be a part of the frame 148, or otherwise a non-distinct portion of the customizable liquid pack 120, that supports the at least one coupling 162 and the insertable receptacle 132 (see FIG. 10B).

As noted above, the extension portion 160 may contain at least one coupling 162 that is configured to couple the insertable receptacle 132 to the customizable liquid pack 120. In FIG. 9, the at least one coupling 162 is illustrated as contacting a neck portion of the insertable receptacle 132 proximal to its opening. However, in some embodiments, the coupling 162 may be coupled to another portion of the insertable receptacle 132. For example, the at least one coupling 162 may be configured to contact a midsection and/or a base of the insertable receptacle 132. In embodiments where the extension portion 160 and/or the at least one coupling 162 supports the base of the insertable receptacle 132, the extension portion 160 may project from the bottom end 144 of the customizable liquid pack 120, and the opening of the insertable receptacle 132 may be positioned below the opening of the fixed fluid receptacles 122.

The at least one coupling may be configured to couple the insertable receptacle 132 to the customizable liquid pack 120 and may be any suitable arrangement. For example, the at least one coupling 162 may be a snap fitting such as a cantilever snap fitting, u-shaped cantilevered snap fitting, an l-shaped snap fitting, a torsion snap fitting, a discontinuous/continuous annular snap fitting. Moreover, other types of snap fittings may be substituted, as this list should not be construed as exhaustive. Alternatively, or additionally, the at least one coupling 162 may not be a snap fit. In some embodiments, the at least one coupling may be a hole sized to receive the insertable receptacle. The coupling may, in some embodiments, hold the insertable receptacle via an interference fit. In some embodiments, the at least one coupling 162 may be a threaded hole that is configured to receive a threaded insertable receptacle 132. As such, a person of skill would recognize that any type of coupling may be implemented as the at least one coupling 162. Moreover, the at least one coupling 162 may be configured to reversibly couple to the insertable receptacle 132, so that the insertable receptacle 132 may be removed after being coupled to the customizable liquid pack 120, and/or the at least one coupling 162 may be permanent, so that the insertable receptacles 132 cannot be (or are otherwise not configured to be) removed from the customizable liquid pack 120. While in some embodiments, the customizable liquid pack 120 may use a combination thereof.

Similar to FIG. 9, FIG. 10A depicts an alternative embodiment of a customizable liquid pack 120 where the couplings for the insertable receptacles comprise holes. In FIG. 10A there are five couplings, two of which have received an insertable receptacle 132. In this configuration, the insertable receptacles 132 are top-loaded into the couplings 162. The couplings 162 may not be configured to deformably fit around the insertable liquid pack 120 and instead may contain a cross section that is larger than a lower portion of the insertable receptacle, but smaller than an upper portion 131 (see FIG. 9) above the neck of the insertable receptacle. This may allow for variably sized insertable receptacles 132 to be used with the customizable liquid pack 120. However, a person of skill would recognize that this structure may be augmented and may instead be configured to support the bottom 133 (see FIG. 9) of the insertable receptacle 132. Moreover, it should be noted that although a circular shape is illustrated for both the insertable receptacles 132 and the at least one coupling 162, any shape may be substituted.

In some embodiments, such as the embodiment detailed in FIG. 10B, the customizable liquid pack 120 may deform when the insertable receptacle 132 is inserted into the coupling 162. In this embodiment, the extension portion 160 is smaller than the extension portion depicted in FIG. 10A as the at least one coupling (and extension portion) is configured to not fully surround insertable receptacle 132. In the embodiment, the coupling may outwardly deform to receive the insertable receptacle 132. In some embodiments, this outward deformation may permit the at least one coupling to operate as a cylinder snap fit joint. Moreover, the insertable receptacle 132 may either be top-loaded and/or side-loaded into the at least one coupling 162 of the customizable liquid pack 120.

Alternatively, or additionally, the at least one coupling 162 may have a clamping or other snap structure that may function to snap the insertable receptacle 132 into place. For example, insertable receptacles 132 may contain a complimentary snap feature that is integrally formed with (or otherwise connected to) the insertable receptacle 132 and may be used to facilitate coupling to the customizable liquid pack 120.

Alternatively, or additionally, as shown in FIGS. 10C and 10D, the insertable receptacles 132 may be retained by an auxiliary hub 164 that is coupled to the at least one coupling 162. The auxiliary hub 164 may be received by an auxiliary coupling 165 on the customizable liquid pack 120. This auxiliary hub 164 may be configured to be secured to a standard size reagent container and/or receptacle. In some embodiments, this auxiliary hub 164 may be coupled to several insertable receptacles 132. For example, as seen in FIGS. 10C-10D, all five insertable receptacles are connected within an auxiliary hub 164. As such, the insertable receptacles 132 may be coupled to the auxiliary hub 164 (via couplings 162) and then all of the insertable receptacles 132 may be simultaneously secured to the customizable liquid pack 120 via an auxiliary coupling 165 on the customizable liquid pack.

In some embodiments, the auxiliary hub 164 may come preloaded with fluid receptacles. The insertable receptacles 132 within this auxiliary hub 164 may be reagents that are commonly used together and/or other testing fluids that may be used to test for complementary variables. For example, if one demonstrated phenotype was linked to different genotypes or genetic mutations, then the set may contain at least one primer for each target genetic sequence. However, it should be appreciated that alternative groupings are contemplated.

As such, it should be appreciated that any number of couplings per insertable receptacle may be used. Although only one coupling 162 per insertable receptacle 132 (FIGS. 10A-10B) and one coupling 162 for multiple insertable receptacles 132 (FIGS. 10C-10D) is illustrated, it should be appreciated that in some embodiments, there may be two or more couplings 162 per insertable receptacle 132. As such, there may be a coupling 162 positioned on the bottom and the top of the insertable receptacle 132.

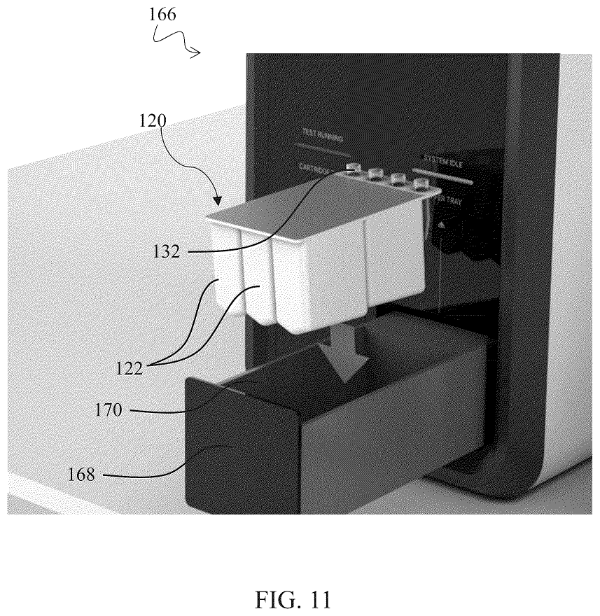

The customizable liquid pack 120 may be loaded and unloaded into the bay 168 of a sample processing instrument 166. Similar to the process of loading the fluid container described above, the customizable liquid pack 120 may be top-loaded, front-loaded, back-loaded, side-loaded, bottom-loaded, and a combination thereof. For example, in FIG. 11, bay 168 is transitioned into an open configuration where an opening 170 of the bay is exposed, the customizable liquid pack 120 is top-loaded into the opening 170 of the bay 168, and the bay 168 is transitioned into a closed configuration.

In some embodiments, a user may be permitted to add, remove, and/or exchange the insertable receptacles 132 while the customizable liquid pack 120 is housed in the bay 168. As detailed below, a sample processing instrument 166 can selectively engage with the fixed receptacles 122 and the insertable receptacles 132. (i.e. at any time, the sample processing instrument 166 may be fluidly coupled to both the fixed receptacles 122 and the insertable receptacles 132, only the fixed receptacles 122 and/or only the insertable receptacles 132.)

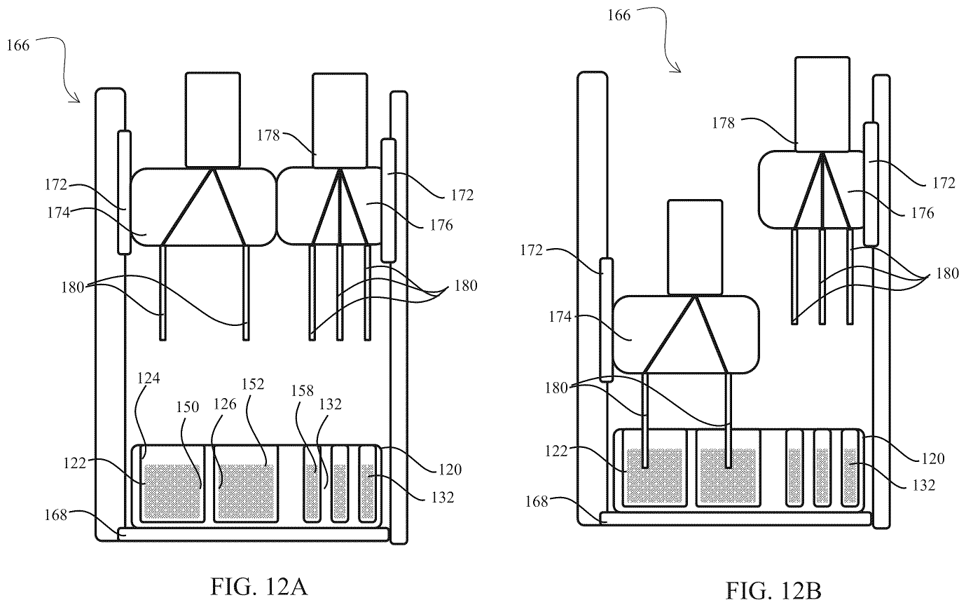

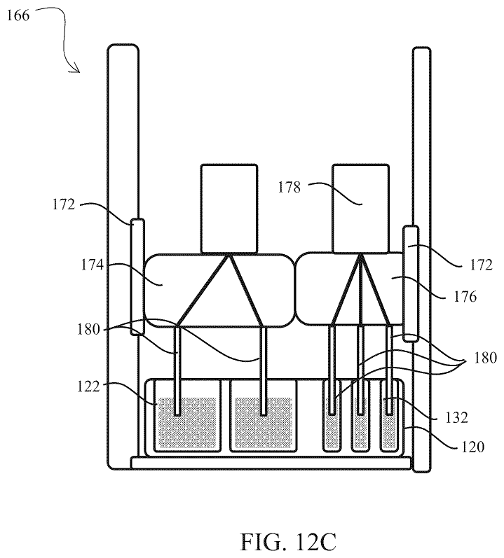

In some embodiments, a sample processing instrument may include multiple elevators. For example, FIGS. 12A-C illustrate a customizable liquid pack 120 with a first working liquid 150 within the first fluid receptacle 124 and a second working liquid 152 in the second receptacle 126 and a third working liquid 158 in the third receptacle 132 within a sample processing instrument 166. The sample processing instrument 166 includes one elevator for fixed receptacles and an elevator for insertable receptacles, where each elevator 172 can raise and lower their respective manifolds associated with a fixed receptacle 122 and an insertable receptacle 132. In FIG. 12A, both manifolds 174, 176 are positioned above the fluid receptacles. In FIG. 12B, the preselected manifold 174 is lowered into the fixed receptacles 122, so that each of the plurality of fluid inlets 180 of the sample processing instrument 166 are inserted into the working liquid within the fixed receptacles 122. The first manifold 176 is still positioned above the customizable liquid pack 120. In FIG. 12C, the first manifold 176 is lowered into the insertable receptacle 132. As noted above, once fluid connectivity is established, a pump 178 may pump the working liquid from the customizable liquid pack to the sample cartridge.

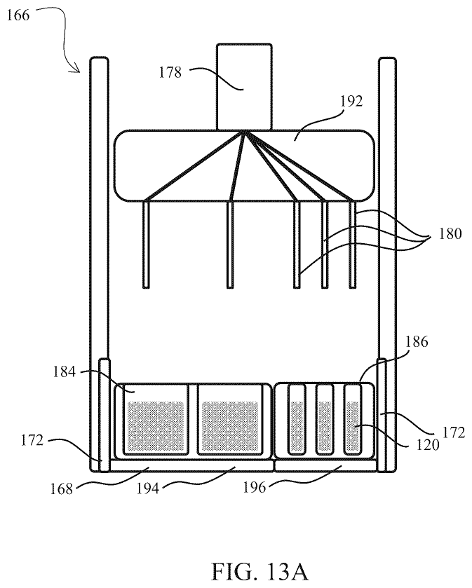

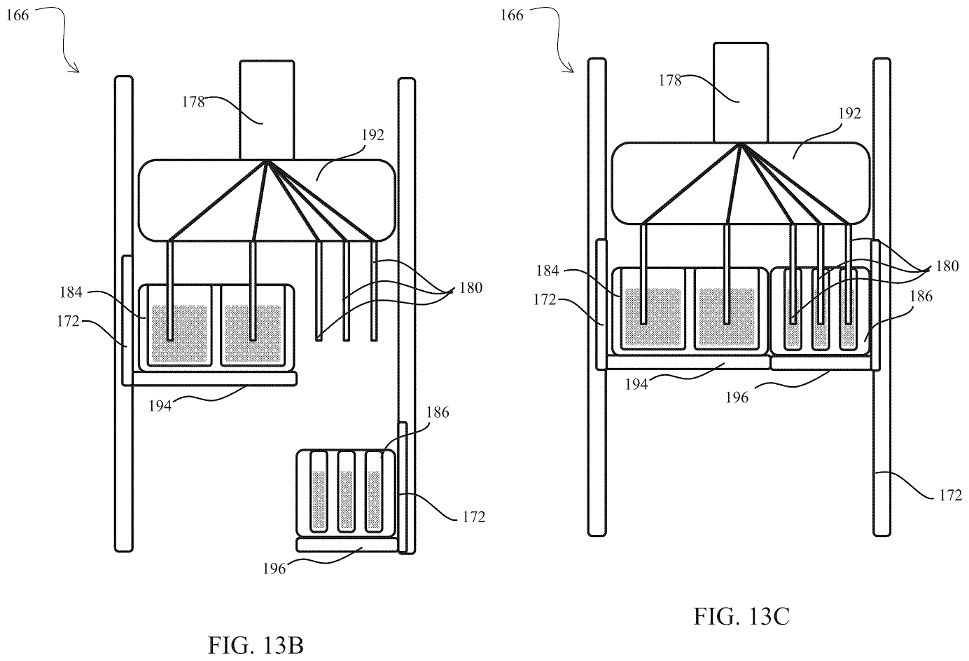

Alternatively, or additionally, the bay 168 may be raised and lowered at different rates. In FIGS. 13A-C, the bay 168 includes multiple loading stations. Although the multiple loading stations are illustrated as a single space with multiple elevators 172, it should be appreciated that the multiple loading stations may have their own distinct volumes. For example, the sample processing instrument 166 may have multiple drawers configured to receive the fixed receptacle 184 and/or the disconnected insertable receptacle 186. Similar to the loading system described in FIGS. 1 and 2, the sample processing instrument 166 the elevators 172 may move the fluid receptacles 184, 186 into a fluid connection with the fluid inlets 180 of the sample processing instrument 166 by raising the fluid receptacles. In FIG. 13A, both bays 194, 196 are positioned so that the fluid inlets 180 are not in contact and/or lack fluid connectivity with the working liquid in the fluid receptacles 184, 186. In FIG. 13B, the disconnected fixed receptacle is raised into fluid connectivity with the manifold 192 by the first bay 194, while the disconnected insertable receptacle 186 remains fluidly disconnected from the sample processing instrument 166. In FIG. 13C, both bays 194, 196 are positioned to fluidly couple the disconnected fixed receptacle 184 and the disconnected insertable receptacle 186, respectively, to the manifold 192 of the sample processing instrument 166.

Generally, when the fluid inlets 180 are lowered and/or the bay 168 is raised to fluidly couple the sample processing instrument 166 with the customizable liquid pack 120, the bottom of the fluid receptacles 122 may be configured to extend below the inlets 180. As such, in embodiments where the insertable receptacles 132 are inserted into the customizable liquid packs 120, the bottoms and/or the openings of the insertable receptacles 132 may be positioned based on the fluidly coupled positioning of the needle inlet 180. In embodiments where the sample processing instrument 166 includes fluid inlets 180 that have a uniform length, and the elevators are not independently controlled, the fluid connectivity of the fixed receptacle 122 may be impacted. For example, if the needle/the fluid inlet 180 is positioned at the midpoint of the fixed receptacle 122, but at the bottom of the insertable receptacle 132 (so that the fluid inlet cannot be further lowered or the elevator cannot be further raised) then not all of the working liquid in the fixed receptacle 122 may be removed and pumped by the pump 178. As such, the placement of the needles or other fluid inlets 180 and/or the structure of the customizable liquid pack 120 may be configured to ensure access to all fluids in the fluid receptacles.

Accordingly, in some embodiments, as illustrated in FIGS. 14A-B, a single elevator 172 is used to fluidly couple the fixed receptacles 122 and the insertable receptacles 132 to the sample processing instrument 166 by using the position of the extension portion 160, the at least one coupling 162 and/or the fluid inlets 180. In these embodiments, the location of the at least one coupling 162 and/or placement of the extension portion 160 (and therefore the position of the opening of the insertable receptacle 132) may be influenced or determined by the movement path of one or more needles (or inlets 180) of the sample processing instrument 166. Alternatively, or additionally, the structure of the customizable liquid pack 120 may influence the structure of the sample processing instrument 166.

As illustrated in FIG. 14A, the tops of the receptacles are aligned with the extension portion, and the bottom of the insertable receptacle is positioned above the bottom of the fixed receptacles 122. As such, the length of the fluid inlets 180 may be sized based on whether the inlets 180 are configured to interface with the fixed receptacle 122 or the insertable receptacle 132. This configuration may decrease the amount of the working liquid from the insertable receptacle that is lost as waste.

Alternatively, or additionally, the customizable liquid pack 120 (or more specifically the placement of the insertable receptacle relative to the extension portion 160) may be configured to operate with a uniform inlet length. For example, the customizable liquid pack of FIG. 14B has an extension portion that extends along the end portion of the sample processing instrument 166. In this embodiment, the bottom of the insertable receptacles 132 and the fixed receptacles 122 are aligned, and the openings of the receptacles are at different heights.

Moreover, it should be apparent from the sample processing instrument 166 of FIGS. 14A and 14B, (and by the fluid containers 120 illustrated in FIGS. 10A and 10B) that in some embodiments, the sample processing instrument 166 may be configured to be fluidly connected to a partly loaded fluid container 120. In such a configuration, at least one of the fluid inlets 180 of the sample processing instrument 166 may extend below the extension portion 160 without being fluidly coupled to a fluid receptacle.

As noted above, the customizable liquid pack 120 may be inserted into a bay 168 of a sample processing instrument 166.

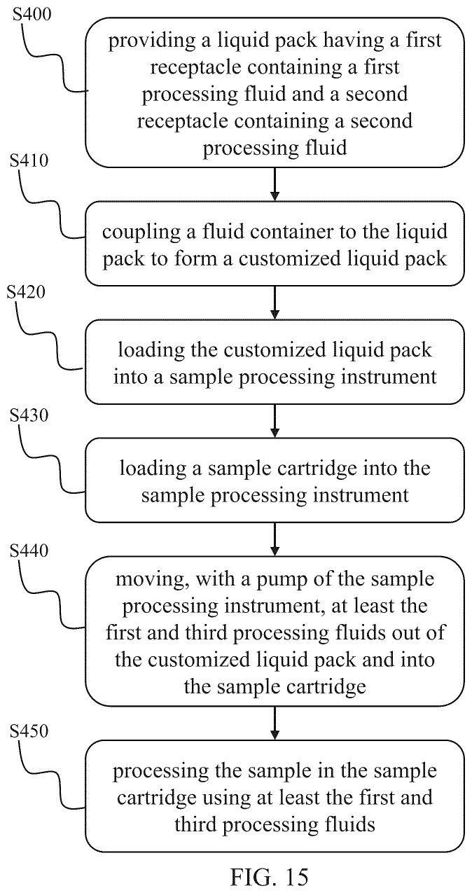

A method of processing a sample within a sample cartridge using the customizable liquid pack is illustrated in FIG. 15. Although the steps of the method are illustrated in a linear sequence, this should not be construed as a temporal order of the recited steps, as each step in the sequence may occur earlier than, later than, or contemporaneously with relative to another recited step. For example, the sample cartridge may be loaded prior to coupling the third receptacle to the liquid pack.

Step S400 recites providing a liquid pack having a first receptacle containing a first working liquid and a second receptacle containing a second working liquid. As noted above, the first receptacle and the second receptacle may be fixed receptacles. The first receptacle and the second receptacle may be sealed in a closed configuration.

Step S410 recites coupling a third receptacle to the liquid pack with a coupling to form a customized liquid pack. As noted above, any number of insertable receptacles may be coupled to the liquid pack to form the customized liquid pack. As noted in step S420, the customized liquid pack may be loaded into a sample processing instrument.

A sample cartridge may be loaded into the sample processing instrument, as detailed in step S430. This sample liquid pack may contain various structures that permit various tests that may be customized based on the applied test. In some embodiments, the sample cartridge may contain lyophilized (freeze-dried) reagents. These lyophilized reagents may form a solute that may be rehydrated with at least one of the fluids within the liquid pack and/or the customized liquid pack. Alternatively, or additionally, if the test was genetic testing, and the sample was an unprocessed sample, then structures and/or elements within the sample cartridge, such as a nucleic acid binding substrate, may be configured to remove the genetic material from the sample. As such, the sample cartridge may contain a filter with various agitating mechanisms and a nucleic acid binding substrate. However, a person of skill in the art would recognize that these structures may be substituted based on the desired target, applicable test and or assay, as a surface binding antigen test may not require cell lysing or binding to a nucleic acid binding substrate.

As described in step S440, working liquid from the customized liquid pack may be moved (e.g., via a pump) into the sample processing instrument and further into the sample cartridge. The fluid moved into the sample device may be the first working liquid and the third working liquid. The movement of the working liquid may be associated with processing of the sample in the sample cartridge. This step is denoted in step S450. In some embodiments, the customizable liquid pack may need to be opened and/or unsealed prior to the moving the working liquid from the receptacles. Moreover, fluid connectivity between the manifold and at least one receptacle may need to be established prior to the movement of the working liquid.

The processing of the sample fluid may entail several steps depending on the application. In some embodiments, once the plurality of cells within the sample are loaded into the cartridge, the sample remains within the cartridge. Moreover, in some embodiments, once the working liquid and/or the sample fluid is loaded into a cartridge, it remains within the cartridge. The steps taken within the sample cartridge may include the following: lysing a plurality of cells of a sample positioned in a lysis chamber of the sample cartridge to release a plurality of nucleic acids; moving the plurality of nucleic acids into a nucleic acid capture chamber of the sample cartridge; capturing the plurality of nucleic acids onto a nucleic acid binding unit in the nucleic acid capture chamber; releasing the plurality of nucleic acids from the nucleic acid binding unit; processing the plurality of nucleic acids released from the nucleic acid binding unit in order to identify an identity of the plurality of nucleic acids; and identifying the identity of the plurality of nucleic acids. However, as noted above, this is merely an exemplary processing procedure and should not be construed as limiting.

In the above example, the sample cartridge received an unprocessed sample. However, this is merely an exemplary application and should not be construed as limiting. In some embodiments, the sample may be processed externally to the sample cartridge and the sample cartridge may be loaded with the processed sample. As such, in some embodiments, processing the sample includes running at least one test and/or assay on the processed sample within the sample cartridge. A person of skill would recognize that the liquid pack (and/or the sample cartridge) may be loaded with various solutions, working liquids, other non-working liquids, and/or reagents may be implemented based on the sample testing procedure and/or outcome.

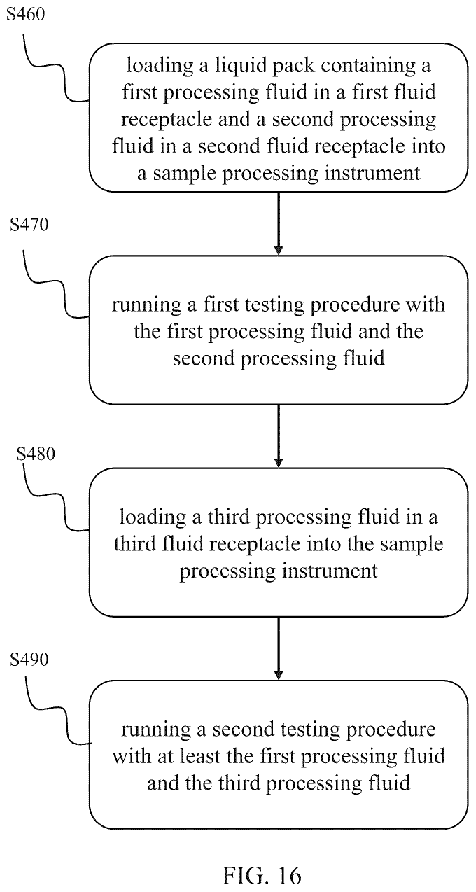

The process of processing a sample is illustrated in FIG. 16. Like FIG. 15, no temporal order should be presumed based on the sequential order depicted in FIG. 16.

Loading the liquid pack is depicted in step S460. The liquid pack may contain a first working liquid in the first receptacle and a second working liquid in the second receptacle, and the loading step may comprise loading the liquid pack into a sample processing instrument. As noted above, a sample cartridge may also be loaded into the sample processing instrument.

Step S470 recites running a first testing procedure with the first working liquid and the second working liquid. As part of the first testing procedure, the first working liquid and the second working liquid may be pumped from the first receptacle and the second receptacle, respectively, into a sample cartridge.

Step S480 recites loading a third receptacle with a third working liquid into a sample processing instrument. Loading the third solution receptacle may entail making a customizable liquid pack. In some embodiments, this may require unloading the liquid pack from the sample processing device. Alternatively, or additionally, the customizable liquid pack may remain loaded in the sample processing instrument while the third receptacle is loaded.

A second testing procedure is recited in step S490. This second testing procedure may include using the first working liquid and the third working liquid. As noted above, the first working liquid (and the second working liquid) may be associated with the fixed receptacles and the third working liquid may be associated with the insertable receptacle. Accordingly, in some embodiments, the method may entail running a first testing procedure using only the working liquid within the fixed receptacles and running a second test procedure using at least one working liquid from the fixed receptacles and at least one working liquid from the insertable fluid receptacles. As such, this may include running a test with the first working liquid, the second working liquid and the third working liquid.

It should be appreciated that the working liquid within the liquid receptacles may be any type of fluid. In some embodiments, the fluid may be a reagent (e.g., PCR primers/probes), a buffer, a solute, a solution, or any other type of cell work fluid. In some embodiments, the working liquid in at least one of the first receptacle and the second receptacle may be a solvent and/or a buffer. The solvent and/or a buffer may be a chaotropic salts (e.g., guanidine hydrochloride, guanidine thiocyanate, isopropanol, ethanol, detergents (e.g., sodium dodecyl sulfate, Triton X-100, Sarkosyl L (N-lauroylsarcosine), HEPES, Tris-HCl, leading and terminating electrolytes for isotachophoresis, pH adjusters, etc. or otherwise configured to react with a solute within a sample cartridge to form a testing reagent or other fluid used in cell testing procedures. This solute may be a solidified reagent and/or testing fluid that is dissolved or otherwise rehydrated by the solution and/or fluid within the customizable liquid pack.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. An open-access customizable liquid pack for sample processing, comprising:
a first receptacle containing a first working liquid, wherein the first receptacle is sealed in a closed configuration;
a second receptacle containing a second working liquid, wherein the second receptacle is sealed in a closed configuration, and wherein the second receptacle is attached to the first receptacle;
an extension portion attached to the first and second receptacles; and
a coupling positioned at the extension portion, the coupling configured to removably receive a third receptacle to couple the third receptacle to the extension portion.

2. The open-access customizable liquid pack of claim 1, wherein the extension portion comprises a cantilevered support.

3-16. (canceled)

17. A method of processing a sample with an open-access customizable liquid pack, comprising:
providing a liquid pack having a first receptacle containing a first working liquid and a second receptacle containing a second working liquid, wherein the first receptacle is attached to the second receptacle, and wherein the first receptacle is sealed in a closed configuration and the second receptacle is sealed in a closed configuration;
coupling a fluid container to the liquid pack to form a customized liquid pack, wherein the fluid container contains a third working liquid;
loading the customized liquid pack into a sample processing instrument;
loading a sample cartridge into the sample processing instrument;
moving, with a pump of the sample processing instrument, at least the first and third working liquids out of the customized liquid pack and into the sample cartridge; and
processing the sample in the sample cartridge using at least the first and third working liquids.

18. The method of claim 17, wherein coupling the fluid container into the liquid pack includes inserting a third receptacle into the customized liquid pack.

19. The method of claim 17, further comprising unsealing at least one of the first receptacle and the second receptacle.

20. The method of claim 19, further comprising unsealing the third receptacle.

21. The method of claim 17, further comprising loading the liquid pack into the sample processing instrument.

22. The method of claim 21, wherein the step of forming the customized liquid pack includes unloading the liquid pack from the sample processing instrument.

23. The method of claim 21, wherein the step of coupling the fluid container to the liquid pack includes coupling the fluid container to the loaded liquid pack without removing the liquid pack from the sample processing instrument.

24. The method of claim 17, wherein a solute is housed within the sample cartridge, and further comprising mixing at least one of the first working liquid and the second working liquid with the solute within the sample cartridge to form a testing reagent.

25. The method of claim 23, wherein the third working liquid is a reagent.

26. The method of claim 23, wherein processing the sample in the sample cartridge includes at least two of:
lysing a plurality of cells of a sample positioned in a lysis chamber of the sample cartridge to release a plurality of nucleic acids;
moving the plurality of nucleic acids into a nucleic acid capture chamber of the sample cartridge;
capturing the plurality of nucleic acids onto a nucleic acid binding unit in the nucleic acid capture chamber;
releasing the plurality of nucleic acids from the nucleic acid binding unit;
processing the plurality of nucleic acids released from the nucleic acid binding unit in order to identify an identity of the plurality of nucleic acids; and
identifying the identity of the plurality of nucleic acids.

27. A method of processing a sample, comprising:
loading a liquid pack containing a first working liquid in a first receptacle and a second working liquid in a second receptacle into a sample processing instrument;
running a first testing procedure with the first working liquid and the second working liquid;
loading a third working liquid in a third receptacle into the sample processing instrument; and
running a second testing procedure with at least the first working liquid and the third working liquid.

28. The method of claim 27, further comprising coupling the third receptacle to the liquid pack.

29. The method of claim 27, wherein the step loading the third receptacle occurs when the first and second receptacle is loaded into the sample processing instrument.

30. The method of claim 29, wherein the first and second receptacle is loaded into a first bay of the sample processing instrument and the third receptacle is loaded into a second bay of the sample processing instrument.

31. The method of claim 27, wherein the first, second, and third receptacles are sealed in a closed configuration, wherein loading the first, second, and third receptacles includes unsealing the first, second, and third receptacles.

32. The method of claim 31, wherein running the first testing procedure and the second testing procedure includes pumping the first working liquid and the second working liquid and the first working liquid and the third working liquid, respectively, out of the receptacles and into a sample cartridge.

33. The method of claim 32, wherein the first testing procedure and/or the second testing procedure includes at least two of:
lysing a plurality of cells of the sample positioned in a lysis chamber of the sample cartridge to release a plurality of nucleic acids;
moving the plurality of nucleic acids into a nucleic acid capture chamber of the sample cartridge;
capturing the plurality of nucleic acids onto a nucleic acid binding unit in the nucleic acid capture chamber;
releasing the plurality of nucleic acids from the nucleic acid binding unit;
processing the plurality of nucleic acids released from the nucleic acid binding unit in order to identify an identity of the plurality of nucleic acids; and
identifying the identity of the plurality of nucleic acids.

34. The method of claim 27, wherein running the second testing procedure further includes using the second working liquid.
